(19) United States
(12) Patent Application Publication
(10) Pub. No.: US 2002/0004803 A1
(43) Pub. Date: Jan. 10, 2002

(54) Method and apparatus for the dynamic modification of relational information in electronic documents such as HTML pages and the like

(76) Inventor: Oleg Serebrennikov, Moscow (RU)

Correspondence Address: DARBY & DARBY P.C., 805 Third Avenue, New York, NY, 10022, US

(21) Appl. No.: 09/810,693

(22) Filed: Jun. 25, 2001

(30) Foreign Application Priority Data
Jul. 4, 2000 (RU) 2000108556
Dec. 5, 2000 (RU) 2000111714

(51) Int. Cl. G06F 15/00

(52) U.S. Cl. 707/513; 707/501.1

(57) ABSTRACT

A system and method for dynamically adding and/or altering relational information in an electronic document is described with reference to Internet web pages. The system and method operate to intercept web pages in transit. Each word or phrase in the intercepted web page is reviewed and checked against a database containing a list of entries and related hyperlink information. For each match, SGML code (e.g., HTML or XML) code containing the link information is written to the re-marked web page in substitution for the original word or phrase. Once complete, the re-marked web page is delivered into the stream from which it was originally intercepted. A revenue generating system and method relating to the above is also described.

### FIELD OF INVENTION

The present invention relates to the dynamic modification of electronic documents. In particular, the present invention concerns a system and method for dynamically adding relational information to the content of the electronic document, e.g., dynamically adding link information to an HTML web page.

### BACKGROUND

One of the most useful benefits of the Internet—and the World Wide Web in particular—is its ability to instantly relate presently displayed information to other information via the use of hyperlinks. As is known in the art, SGML and derivative languages thereof, allow particular words or graphic information in a web page to be visually highlighted and associated with another web page or other electronic document through the use of embedded code. The embedded code includes the IP or DNS resolved address and file name of the related web page or other multimedia file. When a user “clicks” or otherwise designates the linked word or graphic in a displayed document, the web page designated by the embedded IP address and filename is retrieved and displayed on the user's web browser.

When the creator or modifier, e.g., the “webmaster,” of a web page desires to include links in the web page, he must locate the word or graphic desired to be linked and then manually associate the word or graphic with the address and filename of the web page to be retrieved and displayed when the linked word is selected. This process may be accomplished manually by manipulating the HTML text-based file of the web page being created. Alternately, the web page creator utilizes a graphics-friendly HTML source code editor such as Microsoft FrontPage® or Netscape Composer® to add links to the web page being created or edited. In either case, manual intervention is required by the webmaster.

There are many drawbacks to the above-described process. First, in order to modify a web page so as to include a new or additional link, the web page must be removed from service, i.e., made inaccessible to the public, for at least some minimal amount of time while the webmaster implements the modifications. Additionally, the webmaster must have access to the web server where the HTML source code of the web page is located. Moreover, the webmaster must know (or be able to find) the exact location of the web page to be linked and must constantly monitor the status of that web page link to assure that it does not become inaccessible (i.e. expire) when, e.g., the web server for that link is shut down or the address of the linked web page changes. The above-described drawbacks are multiplied where an individual desires to modify the link information associated with a single term that happens to be present in a multiplicity of varying web pages. Even more so, it is difficult to provide such links, as may be desired, to the vast quantity of content (e.g. text) that is already available through the Internet.

What is desired, therefore, and is presently not available, is a method and system for dynamically modifying the link information in an electronic document that avoids the above-described disadvantages of present known systems and methods and that allows for a centralized, automated methodology for manipulating the link information relating to one or more terms in a multiplicity of electronic documents resident on a plurality of web servers.

### SUMMARY OF THE INVENTION

The present invention relates to a method for automatically converting one or more phrases in a hypertext-enabled document to one or more respective hyperlinks. The method includes the steps of: 1) intercepting the hypertext-enabled document prior to being displayed to a user; 2) comparing each of the phrases in the hypertext-enabled document to a database containing a list of words and associated hyperlink information for a match; 3) re-marking the hypertext-enabled document to now include associated hyperlink information in accordance with each match; and 4) displaying the re-marked hypertext-enabled document to the user. In this specification, the term “phrase” includes one or more words.

The method can further include the step of applying the phrases to a morphology database before the comparing step. In this manner, the comparing step operates upon both the phrases and the respective resulting morphs provided by the morphology database.

The present invention further includes a system for automatically converting one or more phrases in a hypertext-enabled document to one or more respective hyperlinks where each of the phrases comprises one or more words. The system includes: 1) means for intercepting the a hypertext-enabled document prior to being displayed to a user; 2) means for comparing each of the phrases in the hypertext-enabled document to a database containing a list of words and phrases and associated hyperlink information for a match; 3) means for re-marking the a hypertext-enabled document to include associated hyperlink information in accordance with each match; and means for displaying the re-marked a hypertext-enabled document to the user.

The present invention further includes a method for generating revenue, wherein a provider of the above-described system charges a fee for each re- marked link.

The fee is charged, e.g. either to a company desirous of securing a maximum number of links to its own website or to an Internet Service Provider to seeking to provide an optimal number of hyperlinks in web pages passing through its facility.

Other objects and features of the present invention will be described hereinafter in detail by way of certain preferred embodiments with reference to the accompanying drawings.

### BRIEF DESCRIPTION OF THE DRAWINGS

FIG. 1 illustrates a first embodiment for the placement of a link creating system of the present invention wherein the link creating system is provided at an Internet Service Provider;

FIG. 2 illustrates a second embodiment for the placement of a link creating system of the present invention wherein the link creating system is provided in the respective users' terminals;

FIG. 3 illustrates a third embodiment for the placement of a link creating system of the present invention wherein the link creating system is provided at a content provider's facility;

FIG. 4 illustrates the preferred method for implementing the link creating system of the present invention; and

FIG. 5 is a logical diagram illustrating an exemplary modification of an HTML-based web page using the link creating system of the present invention.

### DETAILED DESCRIPTION OF THE PREFERRED EMBODIMENTS

The present invention includes a system and method for dynamically adding to or altering relational link information of the content of an electronic document. While the invention will be primarily described hereinafter by way of example with respect to the altering of an HTML-based Internet web page, it is understood that the scope of the claimed invention is defined and limited only by the recitations of the claims which appear at the end of this document. The following detailed description is understood to describe a preferred embodiment only, and does not account for the many possible modifications, variations and alterations that can be successfully accomplished by one skilled in the art when applying the method and system described herein in combination with the recited claims.

At its most basic level, the method and system of the present invention includes three modules accomplishing respective constituent steps: 1) a web page interceptor or receiver for accessing the HTML code of a web page before it is delivered to a requesting user; 2) a link database containing a pre-defined list of words, terms and phrases and their respective associated link information; and 3) a web page reformatter for modifying and augmenting the link information of words, terms and phrases in the web page for each match found within the link database. The web page reformatter preferably includes a query engine which applies data from the intercepted web page to the link database. In a preferred embodiment as described more fully below, the system further includes morphology database which allows “morphs,” i.e., variations, of words in a web page to be compared to the listings in the link database in addition to the actual words, terms and phrases in the web page itself. The query engine preferably integrates the morphology database as well.

Before proceeding to a more complete description of the method utilized to accomplish the above-described steps, the location of the system and its above-described constituent modules will be described.

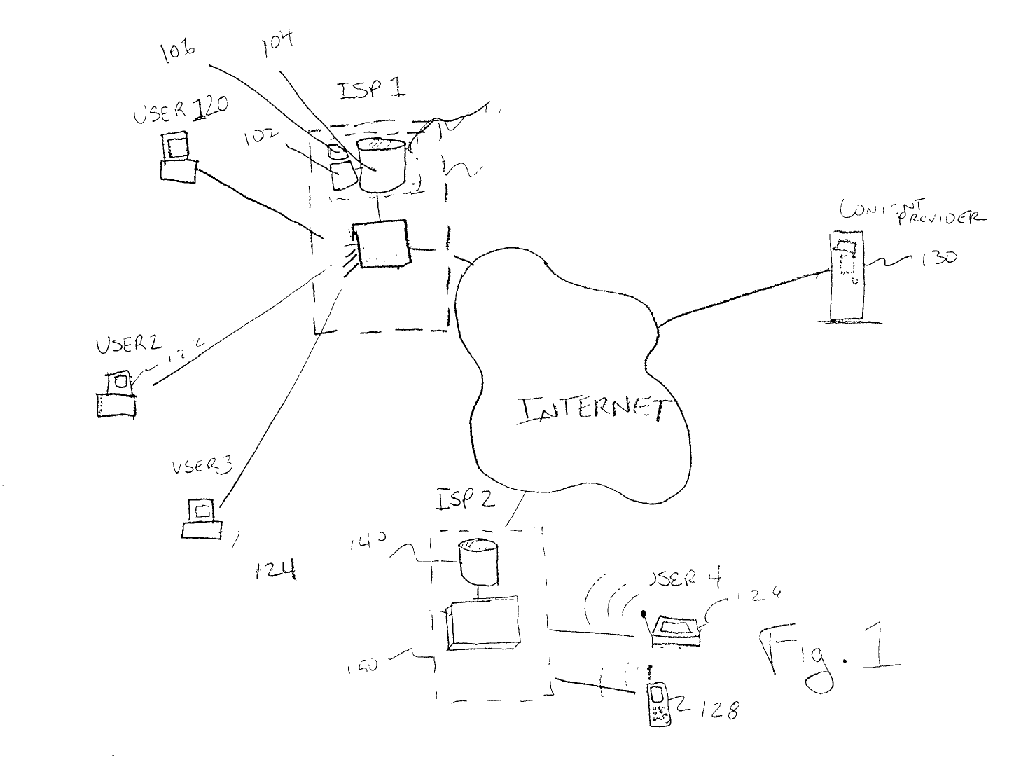

The system of the preferred embodiment includes a computer device or software modules that are strategically placed at a position along the physical and virtual path of a web page in order to allow a requested web page to be intercepted or retrieved before it is delivered to the web browser of a requesting user. In other words, the system of the present invention resides at a virtual or physical location along the path of the web page between the web server on which the requested web page resides and the terminal on which resides the requesting web browser. Three exemplary embodiments of the placement of the present system are illustrated in FIGS. 1-3. In the following illustrations, like numbers indicate like components.

As shown in FIG. 1, the system of the present invention, hereinafter referred to as a link creating system (100), is connected to the path of a web page at Internet Service Provider 110. Although referred to as a “link creating system,” the system 100 can modify an existing link and can also add links to phrases (or words) in a web page where no links of any kind for a particular word or phrase previously existed.

In this embodiment, link creating system 100 can reside at ISP 110, and in any event, it has access to all web pages passing through Internet Service Provider 110. Thus, e.g., Internet Service Provider 110 acts as a web page interceptor in cooperation with link creating system 100 to intercept web pages requested by user 120 from content provider 130. The intercepted web pages are passed to link creating system 100. Once link creating system 100 has manipulated the link information related to the intercepted web page by adding or modifying link information in the requested web page, it passes the re-marked web page back to Internet Service Provider 110. The ISP 110 then provides the re-marked web page to the browser of requesting user 120 in a conventional manner. The method by which the link information of the web page is manipulated will be further described below.

In addition to operating with standard computer terminals 120, 122, 124 link creating systems of the present invention can operate with any mobile computer terminal device, e.g., PDA device 126 and web-enabled cellular telephone 128. Moreover, multiple link creating systems can operate contemporaneously in various ISPs. As shown in FIG. 1, additional link creating system 140 operates in conjunction with ISP 150 to provide service to mobile devices 126 and 128.

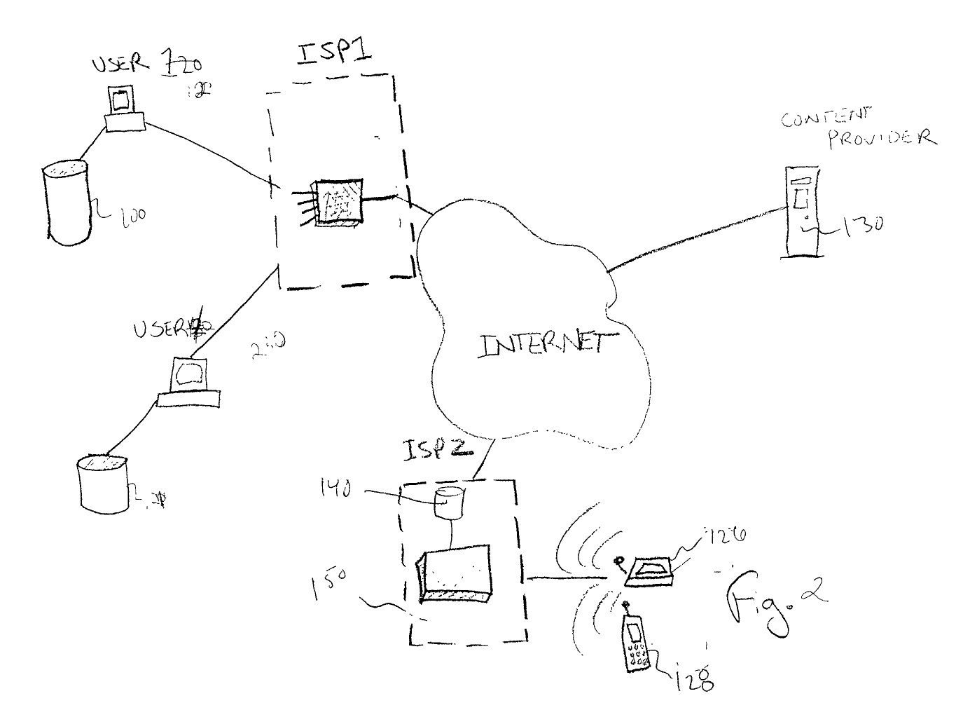

FIG. 2 illustrates a second embodiment in which the link creating system is located at each of the users' computer terminals 220 and 230. Although represented as physically distinct system, link creating systems 200 and 210 of FIG. 2 are preferably software modules associated with the respective web browsers running on each of users' computer system 220 and 230. As an example, link creating systems 200 and 210 may be included in the respective web browsers of each terminal as a web browser plug-in module. The link creating system 200, 210 can be utilized by some other application executed at the user's computer terminal to provide the same functionality with local documents and files. The application can open a communication channel, as needed, to follow any links that have been included in a document or file re-marked by the systems 200 and 210. The re-marking can be limited to a working copy in the memory of the terminal.

In the embodiment of FIG. 2, all web pages destined for respective terminals 200 and 210 are intercepted and manipulated at the users' terminals before being displayed on the browser of respective terminals 200 and 210. It is noted, however, that because of memory constraints, it is preferable not to load a link creating system in each of mobile devices 126 and 128, but instead to provide the link creating system at ISP 150 a shown in both FIGS. 1 and 2.

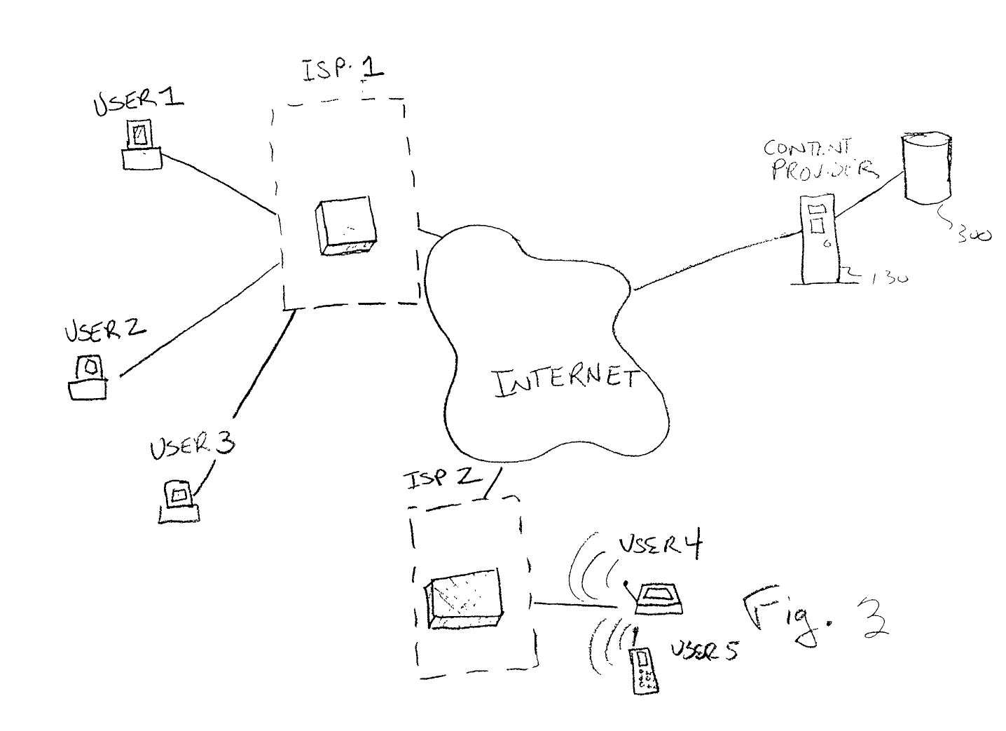

FIG. 3 illustrates a third embodiment in which the link creating system 300 is located and included as a constituent part of content provider's software at web server 130. As in the case of the embodiment of FIG. 2, although link creating system 300 is illustrated as a separate physical element, in a preferred embodiment, link creating system 300 is included as a software module running on web server 130. In the embodiment of FIG. 3, web pages can be manipulated and re-marked in accordance with the methods disclosed herein before they are sent over the Internet to a requesting user terminal.

The embodiments of FIGS. 1 through 3 are represented as singular self-contained units. One skilled in the art will appreciate, however, that the individual components and modules may be distributed in varying locations. Thus, e.g., the link database of a link creating system may be contained remotely from the web page interceptor and/or may be shared among multiple link creating systems in accordance with known methods of distributed networking. With further reference to FIG. 1, the link creating system 100 comprises an interceptor software module 102 a link database 104, a web page reformatter 106 which preferably includes a query engine that parses web pages intercepted by module 102, tests for matches in the database 104, and responds by re-marking the intercepted document or file to output the re-marked file for display at the user terminal. Systems 200 and 300 include the same components. One or more of modules/database 102-106 can be distributed across the network if desired.

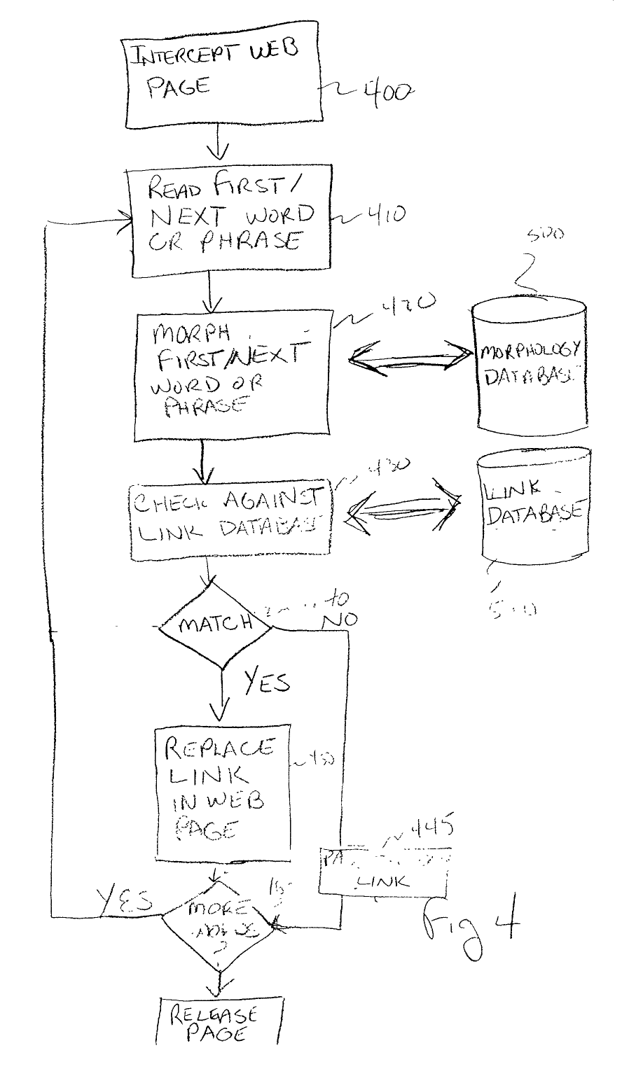

FIG. 4 describes, in flow chart form, the preferred method of the present invention.

At step 400, a web page is intercepted by a web page interceptor in any manner known to one skilled in the art in accordance with the system configurations illustrated in FIGS. 1 through 3. The exact manner in which the web page to be manipulated is intercepted is not a salient aspect of the present invention. Step 400 requires only that a web page be captured at some point before it is displayed on the web browser of the terminal that requested the web page. It is sufficient to hold the contents of the captured web page in a memory prior to it being displayed to a user. Thus, the term “intercepted” is understood to include instances where the web page is deliberately delivered to the link creating system by the content provider, as in the case of the embodiment of FIG. 3.

At step 410, the first phrase in the web page is read. It is understood that a phrase may constitute one or more words in the captured web page and that the present method can operate with respect to phrases containing singular and/or multiple words. Accordingly, the term “phrase” as used herein is understood to mean one or a multiplicity of related words. Thus, e.g., the system and method of FIG. 4 may be designed to manipulate the link information for the word “Internet” in the phrase “Internet Service Provider” or, alternately, to manipulate the entire phrase “Internet Service Provider.”

At step 420, morphology database 500 receives, as an input, the present phrase as read at step 410 and outputs the morph of the phrase, i.e., variations of that phrase such as the plural of a singular noun or the past tense of a verb in the present tense. The present phrase and any variations are held in a phrase work space which is accessed by the matching step described below.

As is known in the art, morphology concerns the study and manipulation of the inflections and derivations of words. The inflection of a word marks categories such as the tense, case and person of the word while the derivation of a word concerns the formation of new words from existing words. Derived words can also be inflected.

Thus, e.g., if the phrase input to morphology database 500 is “Internet Service Provider,” an output of morphology database 500 is “Internet Service Providers,,” i.e., the plural of the inputted phrase. Use of morphology database 500 advantageously allows the linking of a known word or phrase and, in addition, also allows the linking of words that are related to those phrases. However, step 420 is optional because the captured document can be re-marked without regard to morphed word forms in a less robust version of the preferred embodiment.

At step 430, the present phrase and its related morphs (if any) provided by an accessed morphology database 500 are compared against an accessed link database 510. The link database contains a list of phrases and related link information, e.g., the IP or DNS resolved address of a related web page. The link database (and the morphology database) can be the database 104 of FIG. 1.

At step 440, the method of FIG. 4 determines whether a match was found as between the phrases in the phrase work space and any of the entries of link database 510. If no match was found, the system proceeds to step 445 and writes the present phrase to a reconstituted web page. In other words, if there is no match found in link database 510 for the present phrase, the phrase is passed through to the reformatted web page precisely as it existed in the captured document. The system then proceeds to step 460 where the system determines if there are any remaining phrases in the intercepted web page to be examined.

However, if at step 440, the system determines that a match was found between the present phrase and an entry in the link database, instead of the original phrase being written to the reformatted web page as in step 445, the system proceeds to step 450 where the phrase and its accompanying link (as defined by the matching entry in link database 510) are both written to the reformatted web page with the appropriate SGML code (i.e. with HTML formatting or an XML instruction). As an example, if link database 500 contains an entry for the term “Internet Service Provider” that is equal to “www.aol.com,” i.e., the URL for America Online, then the phrase “Internet Service Provider” in the re-marked web page will be anchored to a link to the address www.aol.com.

The system then proceeds to step 460, where, as discussed above, it determines if there are more phrases to be examined in the intercepted web page.

With continued reference to the method illustrated in FIG. 4, if at step 460 the system determines that there are more phrases in the intercepted web page to be examined, the system returns to step 410 to continue the process.

If, however, the system determines at step 460 that the last phrase of the web page has been examined, the system completes preparation of the re-marked web page by adding whatever additional code is necessary, as governed by the link module 106, and then, at step 470, releases the re-marked web page into the stream from which it was intercepted at step 400.

One skilled in the art will understand that there are many variations that can be made to the preferred method described in FIG. 4 without departing from the spirt of the present invention. For example, the system can initially scan the intercepted web page and, if it determines that none of the phrases or morphs of the phrases in the intercepted web page match any of the entries in link database 510, it can release the original intercepted web page back into the transmission stream without re-marking the web page in any way whatsoever.

It is understood that the software of the preferred embodiment preferentially match single words before matching phrases of multiple words in which the single word is found. Alternately, the software can match phrases of words first and single words secondarily. Thus, the system can be designed to match the word “Internet” in the phrase “Internet Service Provider” before matching the entire phrase “Internet Service Provider” if both phrases have entries in link database 500 or the system can be designed to match the phrase “Internet Service Provider” first before the single word “Internet”. Still, a hybrid approach can be used in which entries in the link database 500 are ascribed a value of frequency of use and the reformatter module 106 re-marks the document to include those entries in the link database with the highest value or lowest frequency of use, depending on the criterion established by the software provider for inclusion of re-marked phrases, or its placement in a menu as describe next.

It is further understood that the present invention is not limited in terms of the type or number of links that can be related to any particular phrase. A link may include a simple hyperlink to a single related web page or may include a pop-up menu that relates a phrase to a multiplicity of web pages. Thus, e.g., link database 500 may relate the phrase “Nokia” both to Nokia® Corporation's home page as well as to the web page of a predetermined Nokia® cellular telephone dealer. In this example, the method at step 450 re-marks the web page code such that a pop-up menu appears when the phrase “Nokia” is selected. The pop-up menu preferably has two options: 1) a “homepage” option which, when selected, retrieves the “www.nokia.com” homepage web site; and 2) a “dealer” option which retrieves the web page of the predetermined dealer when selected.

It is further noted that in addition to providing link information to related web pages, the presently-described link creating system may also be utilized to merely replace an existing phrase with a modified or different phrase. This ability is particularly useful where a company wishes to protect its trademark rights. Thus, e.g., the presently described link creating system may be programmed to include the registration mark “®” or the trademark notation“™” upon encountering a certain company name or product. Continuing with the previously described example, the presently-described link creating system may be programmed to append the registered trademark symbol “®” to every instance of the word “Nokia” where the symbol is not presently found.

Alternately, the link creating system of the present invention can be programmed to replace every instance of an encountered word with a different word. This feature is particularly useful in instances of company mergers. Thus, e.g., a link creating system can be programmed to replace every instance of the word “Chrysler” with the term “Dailimer-Chrysler”.

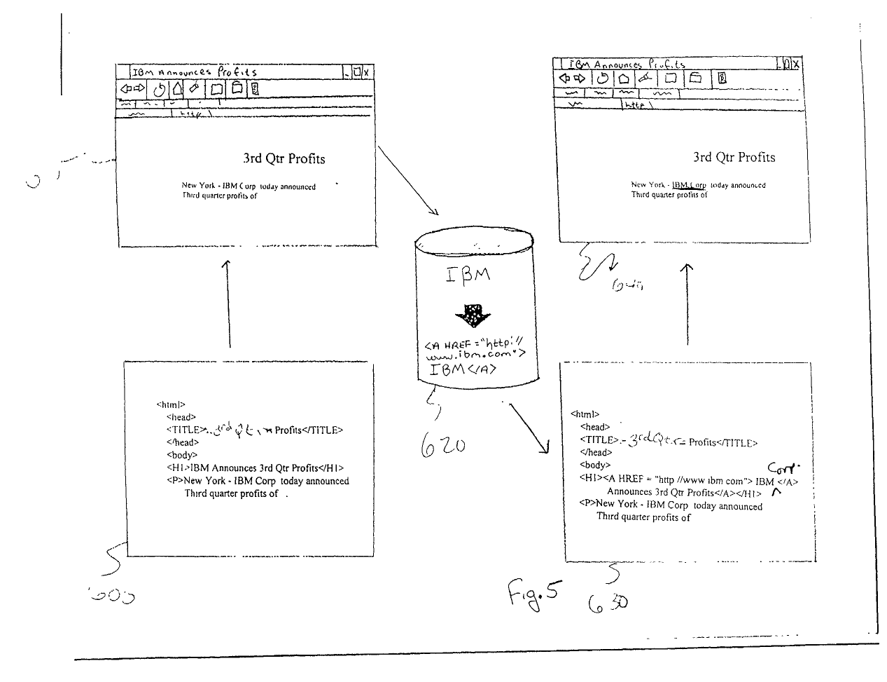

An example of the above described system and method will now be provided with continued reference to FIG. 4 and with additional reference to FIG. 5.

Box 600 of FIG. 5 illustrates the HTML code of an intercepted web page that displays a story concerning IBM Corporation's third quarter profits report for a given year. Only a portion of the story is illustrated in FIG. 5. Box 610 illustrates the appearance of the intercepted web page were it to be displayed on a web browser without the use of the present invention. It is understood that the particular web browser utilized is not critical to the claimed invention and that one skilled in the art can tailor the present system and method to operate with any web browser known in the art and its particular HTML-coding features.

With continued reference to the method illustrated in FIG. 4 and the example of FIG. 5, the text of the HTML code represented in box 600 is processed by accessing the morphology database 500 starting with the first word or phrase in the text, as indicated at step 410. Preferably, only the body of a web page is re-marked since only that portion can include links. Thus, the phrases between the header tags in the HTML code 600 need not be processed. Morphology database 500 (not illustrated in FIG. 5), therefore, processes the text between the HTML tags for inflections and deviations beginning with the phrase “3^{rd} Qtr”. Morphology database returns, e.g., the phrases “third quarter” and “3 Q”.

With continued reference to FIGS. 4 and 5, the process moves to step 430 where the phrases “3^{rd} Qtr,” “third quarter” and “3 Q” are checked against link database 510 for a match. The process moves on to step 440 where it determines that no match is found and, therefore, the phrase “3^{rd} Qtr” is passed through without modification for inclusion in the web page to be displayed to the user (see at step 445).

The process proceeds to step 460 where it determines that additional words in web page 600 remain to be processed and the process therefore returns to step 410.

At step 410, the next phrase “New York” is read and then processed by morphology database 500 at step 410. “New York” and its morphs are checked against the link database at step 430 and, because no match is found and more words are contained in the web page, the process returns to step 410.

Again, at step 410, the next phrase “IBM Corp. ” is read from web page 600. At step 420, the phrase “IBM Corp.” is morphed by morphology database 500. The results of the morphology process, along with the original phrase, are then passed to step 430 where they are checked against link database 500. Step 440 confirms that link database 500 contains an entry for IBM, namely, the web site for IBM Corp. which is www.ibm.com. Accordingly, at step 450, as shown in box 620 in FIG. 5, the phrase “IBM Corp.” is modified to include the HTML link code information “<A HREF “http://www.ibm.com”> IBM Corp </A >.

At step 460, the system determines that additional words in the intercepted web page remain and the process returns, therefore, to step 410.

Box 630 of FIG. 5 partially illustrates the appearance of the HTML-source code of the re-marked web page after the process of FIG. 4 has terminated. As shown, the original unlinked code for “IBM Corp.” has been replaced with the appropriate link information. Box 640 illustrates the appearance of the re-marked web page for display to the user which now includes the hyperlinked term “IBM Corp.”

Many additional advantageous features of the above-described link modification system may be realized in accordance with the claimed invention.

The link modification system, and in particular the contents of the link database, can be tailored to particular users. Thus, a user may select that only links of a certain types or subject matters, e.g., company names, be modified. Moreover, a user may select and particularize the kind of information and web pages that are to be linked, e.g., purchasing information, technical information, scientific information, news information, stock price information, financial information, copyright and trademark information and so on. The user preferably makes the above-described selections via their web browser.

The link creating system can advantageously operate as a revenue generating source. As an example, the present link creating system, complete with a predefined link database can be offered by, e.g., an ISP such as America Online or CompuServe, to companies that desire that all web traffic containing references to their company or products be modified as above to contain links to authorized web sites. In accordance with this method, the ISP generates revenue by charging the particular companies on the basis of the number of modifications performed by the link creating system of the ISP, or for a subscription to the re-marking service.

Alternately, a content provider—e.g., a news organization that provides news content on the Internet and which normally provides its content with the maximum amount of hyperlink information—provisions an above-described link creating system to manipulate all of its web pages before they are delivered over the Internet. In such an embodiment—which is representative of that illustrated in FIG. 3—revenue is collected either from the content provider itself or from those companies desirous of linking all references to their company on pages generated by the particular content provider.

Although the present invention has been described with reference to the manipulation of link information in HTML documents, it is understood that the claimed invention is applicable to SGML in general and to any electronic document that is capable of providing link content to relational information. Thus, e.g., the claimed invention can be used to manipulate “.pdf” files. Moreover, although the above-described embodiments have been described as hyperlinking to other HTML-based web pages, it is understood that the links can relate to text-based, audio, video or any other multimedia-based electronic file. Moreover, the claimed invention is not limited to use on the Internet but is, instead, applicable to any local or wide area network.

1. A method for automatically converting one or more phrases in a hypertext-enabled document to one or more respective hyperlinks comprising the steps of:
intercepting said hypertext-enabled document prior to being displayed to a user;
comparing each of said phrases in the hypertext-enabled document to a database containing a list of words and associated hyperlink information for a match;
re-marking the hypertext-enabled document to include associated hyperlink information in accordance with each said match; and
displaying the re-marked hypertext-enabled document to said user.

2. The method of claim 1, wherein the phrase comprises one or more words.

3. The method of claim 1, further including the step of applying the one or more phrases to a morphology database before the comparing step, wherein said comparing step operates upon both the one or more phrases and the respective resulting morphs from the applying step.

4. The method of claim 3, wherein the morphology database outputs inflections and derivations of an inputted phrase.

5. The method of claim 1, wherein the steps of intercepting, comparing and re-marking are performed by a user's computer system.

6. The method of claim 5, wherein said computer system is a hand-held computing device.

7. The method of claim 1, wherein said intercepting, comparing and remarking steps are preformed by utilizing a user's web browser plug-in functionality.

8. The method of claim 1, wherein said database is sortable by subject matter.

9. The method of claim 8, wherein said user selectably determines the subject matter for comparing.

10. The method of claim 1, wherein an Internet Service Provider performs the intercepting, comparing and re-marking steps.

11. The method of claim 1, wherein said user selectably activates and deactivates said intercepting, comparing and re-marking steps.

12. The method of claim 1, wherein said associated hyperlink information is selected from a group consisting of links to purchasing information, technical information, scientific information, news information, stock price information, financial information, copyright information and trademark information.

13. A method for automatically converting a first set of information to a second set of information indicative of one or more third sets of information, comprising the steps of:
intercepting said first set of information;
comparing said first set of information to a database containing a list of associated second sets of information for a match, said second sets of information being indicative of one or more third sets of information;
modifying said first set of information to include an associated second set of information for each said match; and
displaying said modified first set of information;
wherein, the selection of said modified first set of information causes the display of said one or more third set of information.

14. The method of claim 13, wherein said information is selected from a group consisting of text data, graphical data, audio data and video data.

15. The method of claim 13, wherein:
said first set of information includes text in a web page;
said second set of information includes a hyperlink; and
said third set of information includes a web page addressed by said hyperlink.

16. The method of claim 13, wherein said intercepting, comparing and modifying steps are performed by computer systems selected from the group consisting of a user's system, an Internet Service Provider's system and a content provider's system.

17. A method for generating revenue based on data included in a first set of information to be transmitted in a file to a user connected to a distributed computer network, comprising the steps of:
comparing said first set of information in a database of associations of said first set of information to a second set of information;
modifying said file such that the first set of information references at least one element in the second set of information;
charging for the modifications to said file performed in said modifying step;
sending said modified file to said user.

18. The method of claim 17, wherein said file includes an Internet web page.

19. The method of claim 17, wherein said charging step is directed to a content provider of said first set of information.

20. The method of claim 17, wherein said charging step is directed to the content provider of said second set of information.

21. The method of claim 18, wherein said step of charging is dependent upon the number of modifications performed in said modifying steps.

22. The method of claim 17, wherein said steps of comparing, modifying and charging are performed by a computer system selected from the group consisting of a content provider's system, an Internet Service Provider's system and a user's system.

23. A system for automatically converting one or more phrases in a hypertext-enabled document to one or more respective hyperlinks, each of said phrases comprising one or more words, said system comprising:
means for intercepting said a hypertext-enabled document prior to being displayed to a user;
means for comparing each of said phrases in the a hypertext-enabled document to a database containing a list of words and phrases and associated hyperlink information for a match;
means for re-marking the a hypertext-enabled document to include associated hyperlink information in accordance with each said match; and
means for displaying the re-marked a hypertext-enabled document to said user.

24. A method for formatting a hypertext-enabled document by automatically converting one or more words or phrases to be included in said hypertext-enabled document to one or more respective hyperlinks comprising the steps of:
comparing each of said words or phrases, and morphed variations on said words, to be included in said hypertext-enabled document to a database containing a list of words and associated hyperlink information for a match;
utilizing, in place of said one or more words or phrases, said associated hyperlink information in accordance with each said match in said hypertext-enabled document.

25. The method of claim 24, wherein said comparing and utilizing steps are performed by a content provider.

26. The method of claim 24, wherein said associated hyperlink information is selected from a group consisting of links to purchasing information, technical information, scientific information, news information, stock price information, financial information, copyright information and trademark information.

27. A method for automatically modifying one or more phrases in an electronic document to one or more respective related phrases comprising the steps of:
intercepting said electronic document prior to being displayed to a user;
comparing each of said phrases in the electronic document to a database containing a list of phrases and associated modifying phrases for a match;
re-marking the electronic document to include the associated phrase in accordance with each said match; and
displaying the re-marked electronic document to said user.

28. The method as in claim 27, wherein the one or more phrases each include one or more words.
